(19) United States
(12) Patent Application Publication
(10) Pub. No.: US 2017/0365011 A1
(43) Pub. Date: Dec. 21, 2017

(54) GARMENT SHARING INFRASTRUCTURE

(71) Applicants: Adrik Robert McIlroy, Los Gatos, CA (US); James Bernstein, Boynton Beach, FL (US); Allen Wu, San Jose, CA (US); Guy Mcllroy, Los Gatos, CA (US); Angel Allaire, Toms Rivers, NJ (US); Luke Boyle, Howell, NJ (US); Phil Rizzo, Toms River, NJ (US); Drew Rizzo, Toms River, NJ (US)

(72) Inventors: Adrik Robert McIlroy, Los Gatos, CA (US); James Bernstein, Boynton Beach, FL (US); Allen Wu, San Jose, CA (US); Guy Mcllroy, Los Gatos, CA (US); Angel Allaire, Toms Rivers, NJ (US); Luke Boyle, Howell, NJ (US); Phil Rizzo, Toms River, NJ (US); Drew Rizzo, Toms River, NJ (US)

(73) Assignee: ZOZOme, Inc, Boynton Beach, FL (US)

(21) Appl. No.: 15/186,002

(22) Filed: Jun. 17, 2016

(51) Int. Cl. G06Q 50/00; G06Q 30/02

(52) U.S. Cl. CPC G06Q 50/01; G06Q 30/0214; G06Q 30/0231

(57) ABSTRACT

A system comprising a software application which can be installed on communications devices to create a social network where users can share the contents of their real closet and their aspirational closet including vendor item combined with a means for vendors to tap into said social network and suggest combinations of clothing and accessories including items for purchase to complete the look.

### CROSS-REFERENCE TO RELATED APPLICATIONS

This application claims benefit of U.S. Provisional Application 62/181,849, filed Jun. 19, 2015, hereby incorporated by reference.

### FIELD OF THE INVENTION

### BACKGROUND OF THE INVENTION

Clothing has always been an essential commodity in human societies. But since traditional clothes shopping involves travel to locate desirable items of apparel and checking the fit by trying them on, the process can be frustrating and inefficient.

Typical wardrobe closets merely provide a mechanism for storing a person's clothing. When selecting clothing, a person must search through the wardrobe closet and gather separate articles of clothing to form a coordinated outfit. Often times some articles of clothing may be stored in a portion of the wardrobe closet that make it unlikely that the user will select those articles of clothing. Furthermore, it is often difficult for a person to remember the characteristics of every article of clothing they have stored in their wardrobe closet. As a result, it is difficult to maximize the number of and/or optimize coordinated outfits that can be assembled from a person's clothing inventory.

When shopping in clothing stores or online, shoppers often look at a new article of clothing and try to determine whether or not the new article of clothing will form a coordinated outfit with one or more of the shopper's existing articles of clothing. Unfortunately, the shoppers are forced to try to remember characteristics like the colors and textures of their existing clothing before making a purchasing decision. This imperfect process often results in a shopper returning a purchased article of clothing after seeing the article of clothing next to one or more other articles of clothing.

Recently the Internet has revolutionized clothing sales by providing nearly instant access to retail merchants and inventories worldwide. The availability of personal computers and other similar technologies have introduced significant efficiencies. Indeed, computer-aided clothing sales volumes continue to increase.

### SUMMARY OF THE INVENTION

The invention recognizes that the main thrust of online sales offerings by retail vendors, in various guises, has been to move their storefront window displays onto the Internet, occasionally with animated features, but, in accordance with the invention, it is further recognized that this is done essentially without providing the social networks traditionally used by consumers to make socially acceptable choices. Indeed, the human dynamics of clothes shopping have proved remarkably resistant to change despite the technological advances. For example, group influences conferring social acceptance of one's clothing choices follow largely traditional lines despite recent advances in technology. While online shopping for clothes and accessories over the internet is convenient, frustrations and inefficiencies remain not only for the purchaser but also for the vendor who is unable to find the target customer for their product.

The present invention recognizes that while the exploding success of the social media method of communication has taken on a life of its own, Facebook, Twitter and Snapchat being premier “generalized” worldwide conversation/dialogue platforms, current fashion apps, mostly all substantially standalone apps, do exist ranging from commerce apps to design and presentation apps, but suffer from significant shortcomings. More particularly, the present invention recognizes that existing apps do not provide for instant “chat” conversation or dialogue centering on a very specific topic of conversation. The present invention addresses these limitations in the prior art by providing the opportunity for a vendor to monitor and process the information in real time to provide intelligent shopping suggestions to complete an outfit.

For the individual Internet shopper, it is difficult to imagine how an online purchase will look on oneself, in part because one cannot mix and match with clothing and accessories already owned. For the Internet vendor, it is difficult to target an individual customer if there is no information on what other clothes are accessible to the user and what the user may be missing to “complete the look”.

Therefore, there exists a need in the art for a system that assists the user in managing the user's clothing inventory and facilitates adding additional articles of clothing to the user's clothing inventory. There is also a need to discuss trends in clothing, cosmetics and the general “look” that is prevalent and changes on a minute by minute basis and secondly a means to share visual representations of particular outfits with a user's social network. Without a social network and the social support provided, online shopping is an inefficient and lonely experience. Perhaps just as importantly, the invention provides a method for consumers to make more informed choices and thus not fall into the trap of purchasing garments which are unlikely to be worn. Such prevention of waste also has substantial positive effects on the environment, energy consumption and the like.

The present invention comprises a system and method for creating a social network for sharing fashions combined with an opportunity for vendors to target potential consumers with individualized suggestions to complete an outfit collaboratively.

The present invention provides a virtual wardrobe closet that assists users in selecting and purchasing clothing and assists vendors in identifying clothing or accessory needs. Users are able to share items in their closets with each other both online and in reality. The system gives the user tools to remember what was worn to specific events using a timeline of clothing and events tagged to the user. This allows people to manage the outfits they wear as part of their personal fashion statements and recurrence and give a potential vendor the opportunity to understand a user's preferences, style, and what sort of items could be useful to purchase. Likewise, closet sharing between consumers and vendors allows the assembly of consumer oriented items more likely to be purchased at full price, thus reducing losses for goods which do not sell, must be liquidated at very low prices, and then are unlikely to be used. The system also stores items of potential interest while giving a vendor a back end view. These items could be generic or from a particular vendor.

Rather than giving potential random and/or blindly formulated suggestions on items to purchase, a vendor is given access to a potential customer's closet, their friends' closets, their social media commentary on the items and the desires of that group with normal human preferences and proclivities onto the Internet. In both cases, the near instantaneous availability of worldwide communications introduces significant efficiencies.

In yet another embodiment of the invention, a method of identifying clothing from a vendor that may be of interest to a consumer is provided. The system includes the steps of receiving information identifying clothing owned by the consumer and identifying clothing offered for sale by the store. Next, clothing that may be of interest to the consumer is identified. A representation of the clothing that may be of interest to the consumer is then displayed. Users are provided with an easy way to discuss fashion, discuss what to wear, to ‘try on’ new clothes with the advice of their friends and to see what is available for purchase. The discussions are analyzed for thematic content such that particular items may be found amongst friends for borrowing and amongst merchants for purchasing. Such analysis may be done by vendors for their own use, or the same may be done by the website operator and/or vendors and made available to consumers. In preferred embodiments, the system administrator could procure income from facilitating a loan (where said item requires packing and shipping), placement of pertinent, thematic, merchant sponsorship, advertising and the placement of selected items in a users ‘available’ closet for possible purchase. Likewise, shipping of shared items may be accompanied by targeted advertising generated using color laser printers at the facility of the shipper, for example when moving garments from lender to borrower or during return from borrower to lender.

The inventive apparatus provides for the identification and transportation of a plurality of items, the item being selected from the group consisting of clothing, garment, jewelry, accessories and footwear, owned by a plurality of entities and located at a plurality of locations, and comprises a plurality of first and second physical storage locations. A plurality of first items available for borrowing are stored in each of the first physical storage locations, and a plurality of second items available for purchase are stored in each of the second physical storage locations. A plurality of images representing the visual appearance of each of the items in the plurality of items. A central server is remotely located with respect to the plurality of physical storage locations. A member electronic processing device is associated with each of the physical storage locations, the electronic processing device being programmed to communicate with the central server and enable the processing of information under the direction of the central server, the electronic processing device being programmed to transmit information comprising image information associated with an item to the central server and to initiate an information communication comprising a search inquiry and to collect returned search information. A vendor electronic processing device is associated with a vendor entity. An electronically accessible storage system associated with the central server, the storage system containing a program of instructions responsive to communications inputs into the central server to store in the image storage device, in response to transmission of an image of a first item available to be lent out received from a member electronic processing device, an image of the first item, the image of the first item being associated with data relating to the first item. The image is stored in a storage device, in response to transmission of an image of a second item available for purchase, an image of the second item received from a vendor and available for purchase, the image of the second item being associated with data relating to the second item. In response to a search inquiry a plurality of images of a plurality of responsive items responsive to the search inquiry is output, together with any applicable pricing information and direct transmission of the same to the member electronic processing device initiating the search inquiry. The software receives from the member electronic processing device initiating the search inquiry information indicating a selection of items selected from the plurality of responsive items and generates an outfit representation using the selection of items selected from the plurality of responsive items to cause the representation to be sent to a plurality of member electronic processing devices. The system then is caused to transmit information indicating the selection of the second item to a vendor associated with the second item. The system also maintains a database tracking the number of times items available for purchase from a vendor are selected by members as well as a database of member loyalty award information tracking the number of times each member has assembled an outfit and/or made an item available for borrowing to provide a basis for loyalty rewards. This allows a generation of loyalty reward information and to maintain a database of loyalty reward information. Loyalty reward information may thus be communicated to the vendor to enable the execution of a purchase using the loyalty reward information. The system transmits to computing devices associated with members participating in the assembly of an outfit either as an assembler or as a contributor a message offering shipping services to enable acceptance of the offer and notification to a participating shipper of shipping information.

### BRIEF DESCRIPTION OF THE DRAWINGS

This disclosure will present in detail the following description of preferred embodiments with reference to the following figures wherein:

FIG. 1a is an overview of an embodiment of the inventive method.

FIG. 1b is an overview of a typical execution of the inventive system.

FIG. 2 is a schematic of the users' devices interaction with the application servers and databases via wired and wireless connections to the Internet.

FIG. 3 is an outline of the database structure for the system.

FIG. 4 is a legend or key explaining the meaning of shapes and lines in the flowcharts.

FIG. 5 is a user and system action flowchart illustrating interaction in the context of an item.

FIG. 6 is a user and system action flowchart illustrating interaction in the context of an integrated closet.

FIG. 7 is a user and system action flowchart illustrating interaction in the context of a runway.

FIG. 8 is a user and system action flowchart illustrating interaction in the context of an outfit.

FIG. 9 is a user and system action flowchart illustrating interaction in the context of a user.

FIG. 10 is a screen view of the user's closet ‘items’ page, which shows what clothing items they own or have saved.

FIG. 11 is a screen view of the user reviewing an item and its options.

FIG. 12 is a screen view of the user reviewing an item and its options.

FIG. 13 is a screen view of the user's closet ‘outfits’ page, which shows what combinations of outfits they own or have saved.

FIG. 14 is a screen view of the user reviewing an outfit and its options.

FIG. 15 is a screen view of the user reviewing an outfit and its options.

FIG. 16 is a screen view of the user's closet ‘brands’ page, which shows how their behavior, choices, and other data are connected to brands.

FIG. 17 is a screen view of the runways that the user is involved in.

FIG. 18 is a screen view of a specific runway the user is viewing.

FIG. 19 is a screen view of the user's friends.

FIG. 20 is a screen view of the closet ‘items’ of a fellow user.

FIG. 21 is a screen view of the closet ‘outfits’ of a fellow user.

FIG. 22 is a screen view of the closet ‘brands’ of a fellow user.

FIG. 23 is a screen view of actions with which to add new content into the system.

FIG. 24 is a screen view of the user taking a picture to add into the system.

FIG. 25 is a screen view of the user adding meta data to their item.

FIG. 26 is a screen view of the options having added content.

FIG. 27 is a screen view of selecting friends or groups to interact with over the added content.

FIG. 28 is a screen view of the outfit creator-chooser.

FIG. 29 is a screen view illustrating adding more meta data to an outfit.

### DETAILED DESCRIPTION OF THE INVENTION

Disclosed is a system that allows online users to share fashion decisions with online friends while allowing potential vendors to be part of the suggestion and selection system. The system includes a means by which users can choose which friends to include in specific groups that they can then discuss either as a group or individually. Friends may discuss or display amongst themselves and share choices over clothes in order to help each other decide what to wear. A potential vendor has a window into and access to a forum to discuss trends in clothing, cosmetics and the general “look” that is prevalent and changes on a minute by minute basis and secondly a means to share visual representations of particular outfits with their friends. Such visual representation may be sourced from the users closet and may include any of the users owned, borrowed, available and accessible items from their closet.

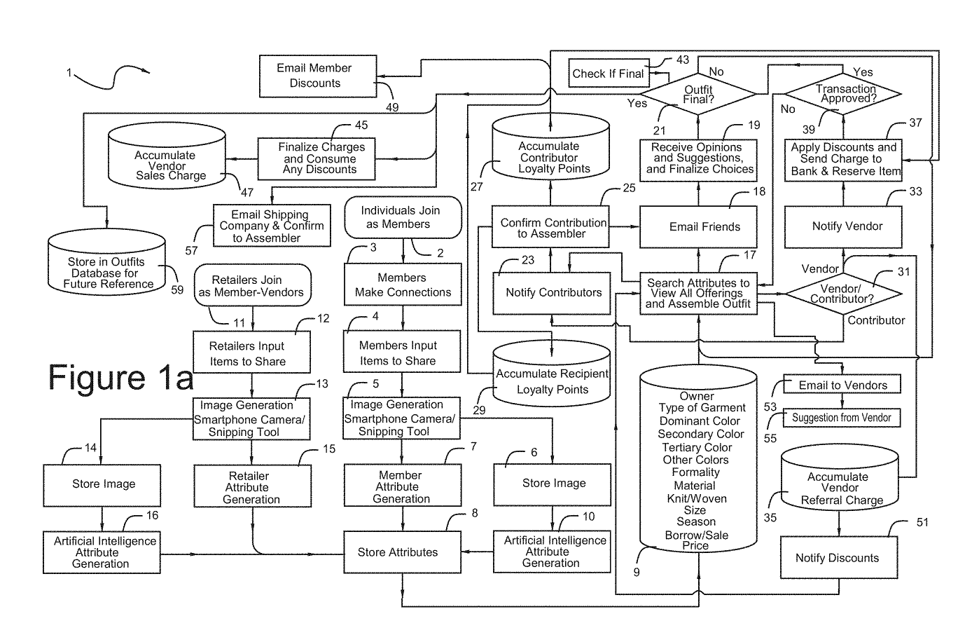

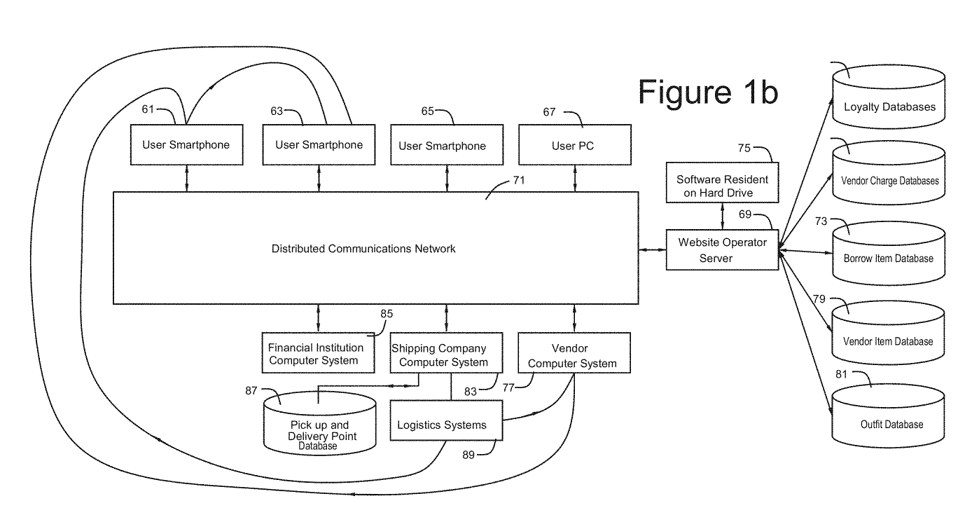

Referring to FIG. 1a, the method 1 of the present invention may be understood. In accordance with this illustrated embodiment of the invention, the inventive method 1 may be initiated at step 2, where individuals log on to the website of the operator of the inventive method, for example by downloading an application.

Subsequently, users may open the inventive application and perform numerous is operations as are more fully described in the following description of FIG. 1, and with more particularity in the description accompanying the remaining figures and this specification.

For example, after opening of the inventive application, members may make connections to “friends” in the application and thus gain viewing and garment requesting access to their friends' closets. In accordance with the invention it is contemplated that members will seek to have numerous friends, which will expand the number of items available for selection in the creation of outfits. Likewise, having numerous friends will enable more feedback with respect to outfit creation, as well as recommendations from friends respecting garments, which they own or see in other closets, which might fit within or improve upon a proposed outfit. In this specification the term “outfit” is meant to refer to a collection of garments and accessories to be worn together and assembled from a member's closet and those of his or her friends. By “friends” is meant individuals connected to a member and who have granted visual access to their garments and presumably are open to sharing their garments. Likewise, references to garments, clothing and accessories are meant to include any and all of them, for example such items as shirts, dresses, shoes, gloves, scarves, belts, jewelry, gowns, dresses, wigs and so forth. While, in accordance with the preferred embodiment of the invention, it is not contemplated that members will share relatively personal items, such as cosmetics, or even wigs, such is possible. However, it is contemplated that merchant members may offer the same.

Once users have loaded the app and become members, as members, individuals may invite other members to be their friends using the app to make connections at step 3. Such invitations may be initiated by the member searching a database of members looking for persons that they know, or by initiating, for example through the app, a message to an individual who is not a member to “friend” them. If the invited individual is a member, the invited member need merely click an “accept” icon placed in the invitation message. If the person is not a member, clicking on the “accept” icon or on a, for example, “join” icon will bring the individual to an invitation page inviting download of the app and offering membership.

While the present description is framed in terms of an app which is designed to allow users to communicate with a system server programmed to provide the functionality described herein, optionally individuals may participate as nonmembers merely by getting on the website and using functionalities such as those described herein to participate in and use the inventive infrastructure. Such non-app based methodology may be in addition to app-based methodology or provided as the only available infrastructure option for practicing the method of the present invention. However, in accordance with the preferred embodiment, participation will be limited to members.

Returning to the description of FIG. 1a, at step 4 members input items of clothing and accessories, which they wish to share. For example, this may take the form of giving the garment or other item a name like “my favorite blouse,” or “my pink shocker pantsuit.” At step 5 an image of the item is generated, for example using a camera, smart phone camera, an existing photograph excerpted using a snipping tool, or any other technique for generating an image. Once generated the image is stored at step 6.

The member then inputs the attributes of the item at step 7. Such attributes may be the type of garment, the dominant color, the secondary color, the tertiary color, other colors, the formality of the garment, the material of which the item is made, such as cotton, wool, wood, silver, plastic etc., the construction, such as woven or knitted, the season for the garment, and so forth. These attributes are then stored at step 8, for example locally at the computer, smartphone or the like being used by the member to access the system server via the app. After the member has decided upon the attributes, the same are confirmed by clicking, for example, a “send” icon causing the attributes in the identification of the item and the identification of the member to be stored on the central server by being sent to the central server over the Internet at step 9.

Alternatively, or in addition, attributes may be generated by use of an artificial intelligence algorithm at step 10 to recognize the nature of the item and determine certain characteristics, such as color. Such use of an artificial intelligence algorithm may also be used to either corroborate member attribute identification. In such case, the discovery of a discrepancy may trigger the sending of a message, through the app for example, to the member making a suggestion respecting attribute identification.

In accordance with the invention, it is contemplated that even with a large number of friends, just the right items to assemble an outfit with a particular look may not be available from one's own personal closet and that of one's friends. Accordingly, the invention contemplates that retailers may function as vendors of items to be included in an outfit being assembled by a member. At step 11, vendors are thus permitted to join into the practicing of the inventive method by joining as member-vendors, for example using a vendor app.

is Once they become member-vendors, retailers may input items into the system at step 12. Likewise, member vendors may generate images at step 13 (or use existing images of items) which may be stored in a local database at step 14. This local database may be updated periodically and uploaded to the remote database used at step 9 or which is accessible to all members and, optionally, member-vendors.

In a manner similar to that used by members at step 7, member-vendors may manually inspect the garments or their images and develop attributes at step 15 which are stored at step 8 and uploaded, via the Internet at step 9, to a remote server operated by the operator of the website hosting software communicating with the member and member-vendor apps.

Alternatively or in addition, an artificial intelligence algorithm may be used to generate certain attributes, and, optionally, compare them to attributes generated manually by the member-vendor. Suggestions may then optionally be sent to the individual manually inputting the attributes. Attributes changed by the retailer, or, optionally, generated by the algorithm may then be stored at step 8 for periodic storage in the remote database use in conjunction with step 9.

In accordance with the invention, it is contemplated that revenue to run the same will be generated by, among other things, advertising. However, advertising revenue is dependent upon use of the system. Accordingly, the invention provides databases and process steps, as are detailed below, for the storage of certain information calculated to provide incentives to members to participate in the inventive functionalities and thus view the website more often. Likewise, the system promotes participation with the effect that more garments and other items are available. This results in the system working more effectively to allow members to put together outfits using their own and their friend's garments, footwear, accessories and other items.

The system also provides for the possibility of multiple levels of sharing. For example, members may define two groups of friends, such as “Close Friends” and “Friends.” With their Close Friends members may share more personal or intimate items, such as footwear, lingerie and the like. However, ordinary Friends who are not Close Friends will not be able to see or ask to borrow such more personal or intimate items.

Returning to FIG. 1, members initiate the assembly of an outfit at step 17. Optionally, they may first identify garments in their own closets, or they may recall a particular garment from the closet of a friend, perhaps a garment, which was seen in person being worn by that friend. At step 17 the outfit assembler may query the database generated at step 9 with keywords calculated to identify items with desired color, formality, material, owner, etc. The assembler then selects those items desired in the outfit and the identity of the items selected for the outfit, together with their images may then be messaged to friends at step 18, for example, for comment and feedback. At step 17 the outfit assembler would also identify the date on which the outfit is to be worn. In this specification messaging may be used or may be replaced by an email. In setting up the app, users may specify their preference for receiving messages and such preference may be accommodated by the app.

At step 19, friends who receive these messages may send opinions to the assembler. This allows the member who is assembling the outfit to inform the system at step 21 that the outfit is final.

However, before an outfit may be made final, all items must be available to the assembler. Accordingly, after assembly at step 17, friends whose items have been identified in the assembled outfit receive messages at step 23 that they are being requested to contribute items to the outfit. Such messages, for example a picture message, would have the name of the requester and, optionally, would also include a composite picture of the outfit with all the various contributed, purchased (or to be purchased) and owned items. In accordance with the invention contributors confirm their contributions at step 25.

As an incentive to participation, contributors are given contributor loyalty points at step 27. Likewise, to encourage participation and also the careful handling of borrowed items, persons assembling outfits are given loyalty points at step 29. Loyalty points have real value to members, who may redeem them for optionally dollar and/or percentage discounts, and/or free shipping to be applied to purchases from retailers who are member-vendors, as appears more fully below.

In accordance with the invention, participation in the inventive system is further provided by sending messages at step 25 to friends notifying them that one of their friends is allowing friends to borrow garments. This encourages persons receiving such messages to look at the closet of the person allowing the borrowing to see if there is something, which they might find interesting.

In accordance with the preferred embodiment, vendors are allowed to participate in the system. Accordingly, in such a system, selections must be determined to be those of a contributor or a vendor by the system proceeding after step 17 to query the database at step 31 as to whether the item comes from a vendor or contributor. If the item comes from a contributor, the same is notified to the contributor. When items are selected during outfit assembly at step 17, if an item is determined at step 31 to be an item from a vendor, and such item must be purchased, the system proceeds at step 33 to notify the vendor. Because the vendor has been given a referral, the vendor referral is then databased at step 35. In this manner the total number of referrals discounted, and appropriate charge may, optionally, be made to the vendor for the referral.

After the vendor is notified at step 33, the vendor proceeds at step 37 to retrieve discounts and offers applicable to the outfit assembler from the points stored at steps 27 and 29. These take the form of discounts, which are applied at step 37. Also at step 37, a financial institution is contacted, also over the Internet (or other distributed network which may be substituted for the Internet in all cases in accordance with the invention), to determine whether the charge is approved. The system thus proceeds at step 39 to query the bank or other institution as to whether the charges are approved. If the charges are not approved, the system sends a message or an app message to the outfit assembler who proceeds at step 17 to replace the item the purchase of which was not approved. Conversely, if the purchase is approved at step 39, the system proceeds to query the outfit assembler as to whether the outfit selection is final. If the answer received is that it is not final, the system proceeds back to step 17 where changes may be made by the outfit assembler.

Periodically, in accordance with the invention, the system may optionally send emails and/or app messages to the outfit assembler at step 43 querying whether the outfit selection of items is final. Whenever the response is “no,” the system proceeds back to step 17. However, when a positive response is achieved, the system proceeds to finalize charges at step 45, charging the credit card and using any available discounts. Optionally, in accordance with the invention, the system may, at step 47, also make a supplemental charge to a vendor in the event of a successful sale that has survived the vetting process of member participation.

Optionally, the buyer-outfit assembler may choose which discounts or offers to use on a particular purchase. To facilitate this and further to encourage consumption, members are messaged at step 49 regularly with communications giving them the number of loyalty points, which they have accumulated.

Optionally, at step 51, the system may send an email or app message to the buyer and outfit assembler notifying him or her of available discounts and promotions applicable to the vendor item whose purchase is being considered. Such discounts and promotions need not be limited to loyalty point rewards but may also consist of other offers being made by the member-vendor.

In accordance with one embodiment of the invention, optionally, vendor-members may take a proactive role, by being informed after step 17 of the tentative, or optionally even the final, formation of an outfit, by receiving, for example, a message at step 53 describing the outfit. Once so informed at step 53, member-vendors may study the outfit and make suggestions at step 55 to the outfit assembler, by email and/or app message. Likewise, means may be provided for regular follow-up on the outfit.

Further in accordance with the invention, it is contemplated that the inventive system will offer shipping options, not only for purchased items, but also for borrowed items. The same can be mechanized by the sending of messages, for example, or other communications at step 57 to all contributors offering pickup and delivery service, for example, in the event that contributors or outfit assemblers are not interested or able to make a trip to retrieve the items.

Referring to FIG. 1b, a typical execution of the inventive method would involve a plurality of users 61, 63, 65, and 67 downloading the app from the website operator's servers 69, via a distributed communications network 71, such as the Internet. Users may use smart phones or personal computers or any other suitable computing and/or communications device, using services provided by their Internet service providers. Using the app, user-members then download their items to the borrow item database 73 using server 69 which is controlled by software resident in its hard drive 75.

In similar fashion, vendors 77 download items for sale onto vendor item database 79. User 63 then communicates via the network 71 with server 69 using the app to search the vendor item database 79 and the borrow item database 73 and assembles an outfit. This outfit is communicated to two servers 69 using the app which, in turn, sends messages to other member-users 61, 65 and 67 informing them of the contents of the outfit and inviting them to send a message, for example, in the app, to the assembler of the outfit of member user 63. Communication then ensues at the option of the member-users.

In the example, member user 63 has identified an item of clothing in the closet of member user 61. Accordingly, this information is stored on outfit database 81. In response to this information, server 69, under control of the software on hard drive 75, sends a message to user 61 that one of that user's items has been requested and identifying that item. User 61 then replies, optionally by message, or by logging onto the application, with the agreement of user 61 to lend the item to user 63. This information is communicated to server 69, which then offers the option of shipping to, for example, user 61, user 63, or users 61 and 63. Upon receiving acceptance of a shipping offer, such information together with other needed information such as the address of the lender and borrower are emailed to shipping company 83. Shipping company 83 then deploys a logistical system, such as a truck to pick up the item at, for example, the home of user 61 and delivers the item to user 63.

In accordance with this example, member user 63 has also identified an item of clothing for purchase from vendor 77. Accordingly, vendor 77 communicates via network 71 with financial institution 85 to have the purchase transaction approved. Upon receiving such approval, shipping company facility 83 is contacted by vendor 77, and the shipping company deploys, for example, truck 89 to vendor facility 77 for pick up of the purchase and delivery to user 63. In accordance with a preferred embodiment, pickup and delivery information for numerous vendors and user members is stored in a pickup and delivery point database 87 to enable efficient execution of the movement of items included in outfits.

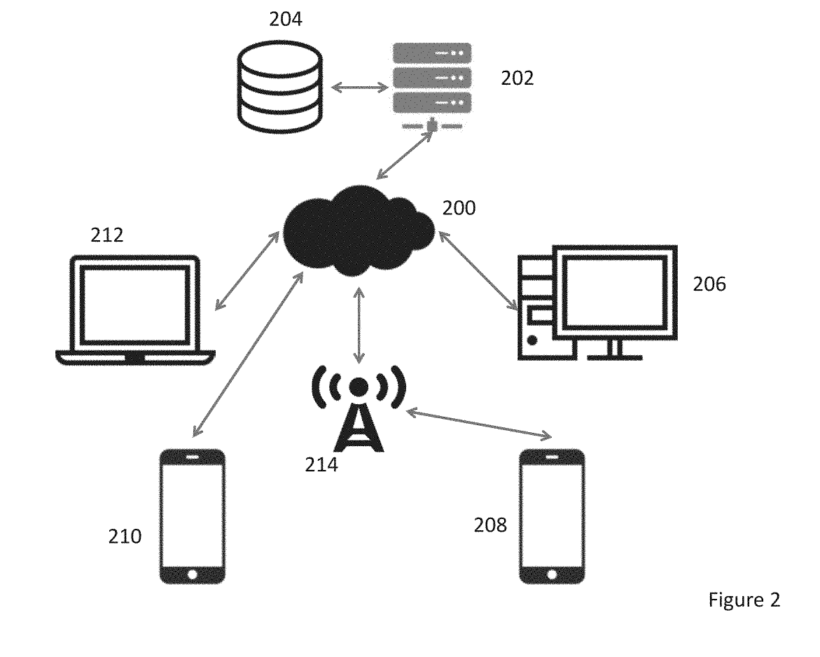

FIG. 2 shows a schematic layout of the inventive system 200. System 200 comprises application server 202, data store 204, computer device 206, a first mobile device 208, a second mobile device 210, laptop 212, and cellular infrastructure 214. All devices are connected to and through the Internet 215.

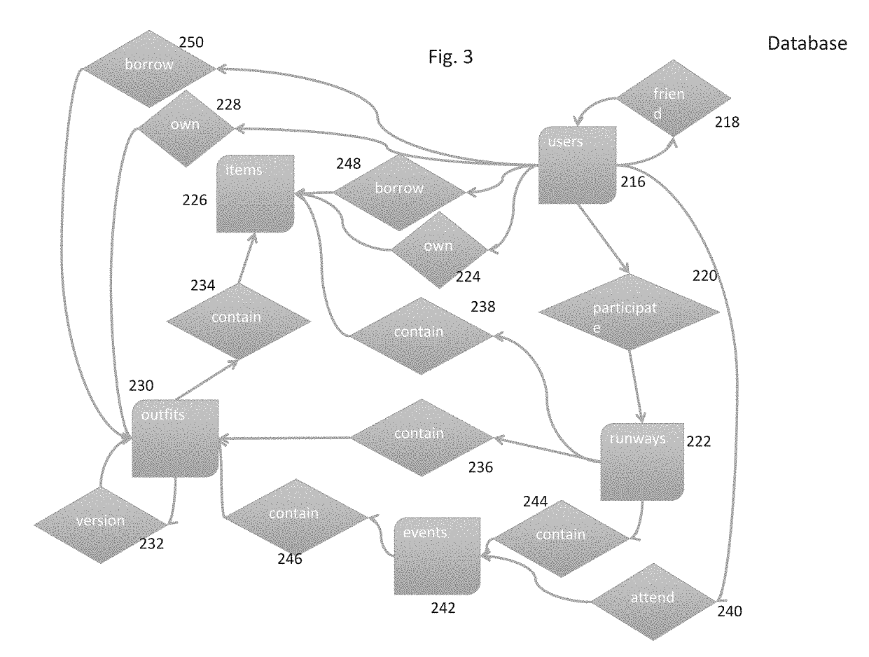

Application server 202 negotiates communication of the user devices such as computer 206, cellular mobile device 208, and wireless or mobile device 210 to each other and database 204; analyzes the behavior and usage of each user to determine recommendations, suggestions, market data, trends, and predictions; and facilitates the functioning of the invention across the internet. Data store 204 stores the data structure for the system. Data store 204 is described in detail in FIG. 3.

System 200 may be accessed via computer to accesses the system and the network of other devices, applications, and databases in the system. Mobile device 208 is used to accesses the system, the internet, and the network of other devices, applications, and databases in system 200 over a cellular infrastructure 214. Mobile device 210 is used to access system 200 via the internet 215 and the network of other devices, applications, and databases in system 200 through wired or wireless connection. Laptop device 212 is used to accesses the system 200, internet 215, and the network of other devices, applications, and databases in system 200 through wired or wireless connection. In preferred embodiments, a mobile application (iPhone, Android/Windows), which provides seamless integration between system users with Facebook or Twitter users friends/timeline/news feed to provide a seamless fashion and clothing experience within the context of the user's existing social media world.

It will be appreciated that the network connections shown are exemplary and other ways of establishing a communications link between the devices can be used. The existence of any of various well-known protocols, such as TCP/IP, Frame Relay, Ethernet, FTP, HTTP and the like, is presumed, and devices can be operated in a client-server configuration to permit a user to retrieve web pages from a web-based server. Furthermore, any of various conventional web browsers can be used to display and manipulate data on web pages.

The operation of the components of system 200 can be controlled by a variety of different program modules. Examples of program modules are routines, programs, objects, components, data structures, etc., that perform particular tasks or implement particular abstract data types. The present invention may also be practiced with other computer system configurations, including hand-held devices, multiprocessor systems, microprocessor based or programmable consumer electronics, network PCS, minicomputers, mainframe computers, personal digital assistants and the like. Furthermore, the invention may also be practiced in distributed computing environments where tasks are performed by remote processing devices that are linked through a communications network. In a distributed computing environment, program modules may be located in both local and remote memory storage devices.

FIG. 3 is a schematic view of the database structure for the system of data store 204. Database 216 includes the users and their associated real and meta data in the system including tags, behaviors, context, and associations marked by the user or generated by the system. The user may add emotional or sentimental tagging for clothes as well as informational tags. A user would understand the importance and significance of what they wear and share and read others' stories behind their favorite articles of clothing.

Users in database 216 are bi-directionally connected to each other as “friends' via a friend function 554 and stored in the relation store 218 of information of how users are related to each other by ‘friending.’ System 200 manages the data sets associated with users and their closet and merchants and their uses and the conversations between friend. Participate relation store 220 stores information to track how users are involved in runways, which each other, the system, and 3^{rd} parties via actions 423, 422, 420, 418, and 416 as detailed in the figures below. ‘Runways’ are conversations and working collaborations where users discuss, compare, and create items and outfits together. Friends may use the system to organizing parties where friends can get together to discuss and share fashion ideas and exchange clothing items. possibly with ‘fashion parades’ were friends share their best ‘dress ups’ with each other. Users could have a virtual “hall of fame” where users can “retire” certain items of clothing for other users to view. Live chats would allow users to submit questions to be asked by our moderator which could be a live person or AI.

Data store 222 stores information on user runways, the objects that store the conversations in the system, and their associated real and meta data in the system. The information from runways can be analyzed by the system historically for trends and market information and user behavior. System 200 can analyze user conversations for themes and memes that are then used to promote content and brands.

Users can tag each item of clothing with various attributes that help search for items later (color, brand, last worn, etc.). Users can browse their closet (including borrowed, available and accessible items) to see each item by various groupings or by tag selections. Relation store 224 tracks which users own which items in data store 226 in the system (and so they show in their closet as such). Users can source pictures of their clothes from merchant websites, each other, and by taking photos the clothes or of themselves wearing the clothes. A user can digitally change the color of a garment in a photo so that users can see what a garment would look like on them in a different color.

Data store 226 stores information on apparel and accessories uploaded by users or 3^{rd} parties into the system as well as the associated real and meta data in the system. The information can be analyzed historically for trends and market information and user behavior. While data store 226 has information on the individual items, relation store 228 is used by the system to track how users ‘own’ certain outfits in the system and how the individual closets are displayed. The outfits, the objects that store the collections apparel curated by users, the system, or 3^{rd} parties into ‘outfits’ are stored in data store 230 as well as their associated real and meta data. Relation data store 232 contained information on how outfits have a version history of changes made to them by users, the system, or 3^{rd} parties through actions such as 470, 472, 498, 500, 502, 504, and 506.

By pulling together outfits, relation store 234 is used in association with 232 to track the individual items in 226 that make up the outfits in 230. Relation store 236 tracks which outfits and their versions are associated with which runways so that those outfits may be shared, revised, used, tagged, and any other actions in conversations with other users and 3^{rd} parties in the system. Relation store 238 tracks which items and their versions are associated with which runways so that those items may be shared, revised, used, tagged, and any other actions in conversations with other users and 3^{rd} parties in the system.

Event data store 242 contains the objects that store the real world or virtual gatherings or otherwise events uploaded by users or 3^{rd} parties or algorithmically generated into the system, and their associated real and meta data in the system. Contain relation store 244 tracks the information between the events 242 and runways 222 data stores and how runways ‘contain’ events so that they may appear and be coordinated and manipulated in those conversations. Contain relation store 246 connects events 242 and outfits 240 data stores to track how events ‘contain’ outfits so that they may appear and be coordinated and manipulated in relation to those events, as well as be analyzed by the system historically for trends and market information and user behavior. Attend relation store 240 connects events 242 and users 216 data stores to track how users are associated with events so that they may coordinate outfits and for specific events. The option for tagging may include Short stories describing the importance of an item or suit and events or times where they had special meaning.

Relation store 248 tracks how and which users from 216 ‘borrow’ or buy certain items from 226 in the system (and so they show in their closet as such) that are ‘owned’ by other users, the system, or 3^{rd} parties. Relation store 250 tracks how and which users from 216 ‘borrow’ or buy certain outfits from 230 and their associated items from 226 and 248 in the system (and so they show in their closet as such) that are ‘owned’ by other users, the system, or 3^{rd} parties. As well as be analyzed by the system historically for trends and market information and user behavior.

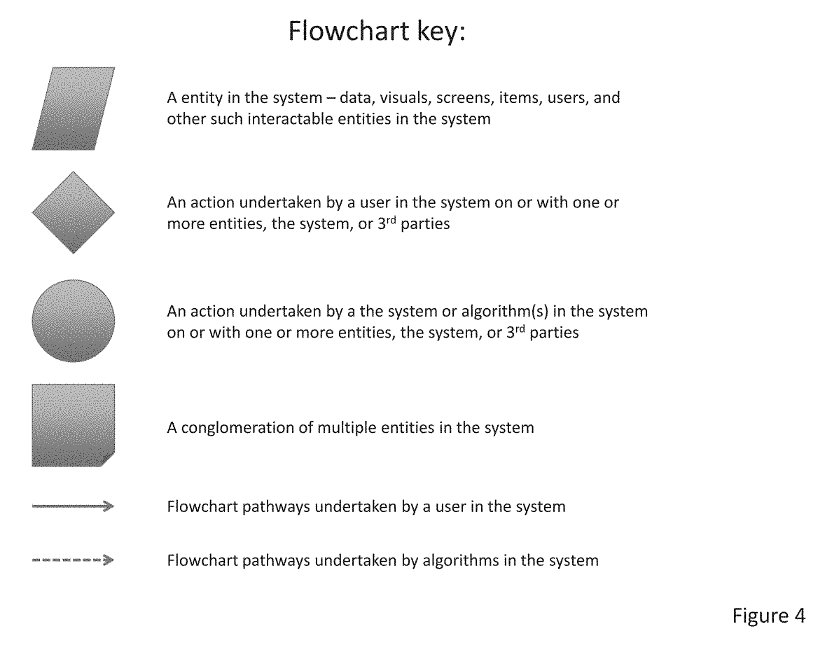

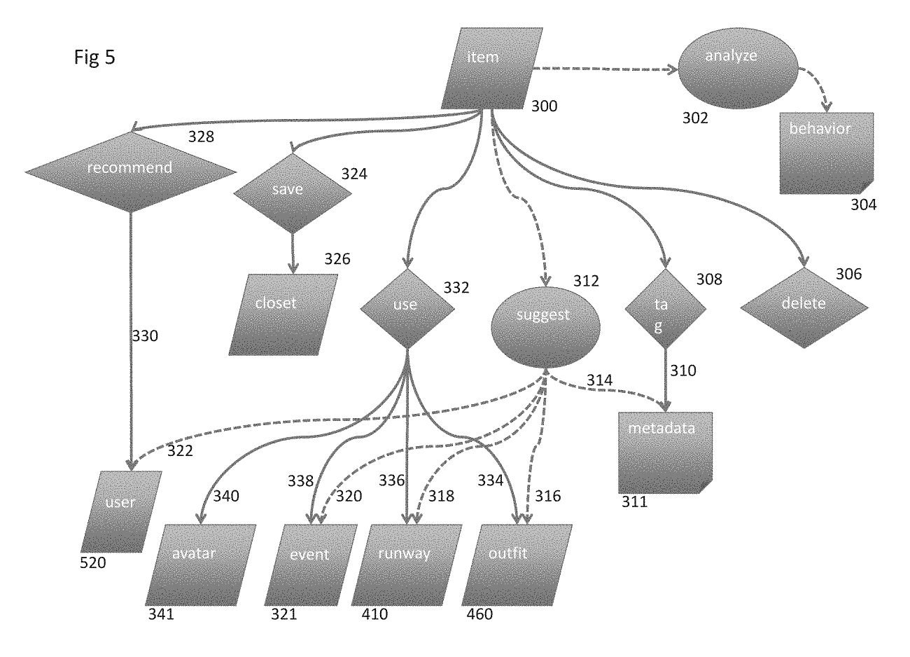

FIG. 4 is a flowchart key to expand upon the symbols used in connection with FIGS. 5-9.

Referring to FIG. 5 shows a schematic view of the user and system action flowchart for interacting in the context of an item. Items 300 are the apparel, clothes, accessories, pets, ‘selfies’, 3d renderings, and otherwise content uploaded by users or 3^{rd} parties into the system, and their associated real and meta data in the system. When a user is interacting with a specific item 300 from items datastore 226 (their own, another user's, the system's, or 3^{rd} party's), they can interact with it by deleting it, tagging it, using it in a variety of actions, changing its color, saving it to a closet, and recommending it to other entities. The system can interact with the user and the item by suggesting a variety of actions and entities, and analyzing the behavior, context, and any other real or meta data.

The system via function 302 analyzes behavior, context, and any other real or meta data related to the item and users' interaction with it in order to serve recommendations, trends, market data, and other machine intelligent derivations. The information is stored in behavior module 304 giving information into the behavior, context, and any other real or meta data related to the item and users' interaction with it.

Delete function 306 allows the user to delete the item from the user's perspective, if they have sufficient privileges. This may or may not delete it from other parts of the system or the system as a whole. The user can also use the tag function 306 to tag the item with metadata. The metadata is stored in module 310 and allows users to search, understand, filter, and otherwise distinguish items while the system as a whole can analyze the information for future use. Metadata 311 is the collection of all attributes, tags, given and calculated information and otherwise data about other data in the system.

When the user is in the context of an item, the system via suggestion function 213 may suggests an array of entities for the user to interact with and create based on machine intelligent analysis of the item and the item's context in the other entities and learned trends in the system. Via connection 314 the system may suggest metadata to add to the item. The system suggests outfits for the user to use this item via connection 316 to be connected to datastore 230.

The system via connection 318 may suggest runways from datastore 222 or via connection 320 to access events 242 for the user to use this item with. 321. System 200 also can support the integration of virtual backdrops whereby users can see what their outfit might look like against a city street or a mall setting. “Events” are objects for storing data related to real or virtual events associated with the user, their items, and their outfits so that a user can do a number of things, including: remember what they have worn to specific events using a timeline of clothing and events you attended; manage the outfits they wear as part of their personal fashion statements and recurrence. Events also provide the means to envision how a particular outfit will look in a certain location by allowing the user to picture themselves and their friends wearing an outfit against a background of a particular event setting. By sharing with friends, friends can coordinate their outfits, along with the background of the event Via connection 322 back to user database 216, the system may suggest other users for the user to use, recommend, revise, and otherwise interact with this item with. A vendor with or without the assistance of the system could a prediction/suggestion on what could be purchase to complete the outfit based on a number of factors including previous similar events, running trends for similar events, conversational threads and memes, and behavioral analysis in response to fashion and event stimuli. In a preferred embodiment, a user may ask for help to match an item (e.g. what items go with my item to make a suit.) They user may also be provided support for user clothing designed that can be ‘picked up’ by a manufacturer for production.

In a preferred embodiment, system 200 establishes an “authority” on fashion whereby users can ask what the general consensus is as far as what is ok to wear. This authority to be driven by both AI (artificial intelligence) driven by conversational analysis and by real, popularly acclaimed, fashion divas.

When the user is in the context of an item from anywhere in the system (other users, 3^{rd} parties, algorithms) or even their own closet through the integrated closet, the user can save the item via save function 324 it into their own closet permanently (until they choose otherwise). When a user saves an item into their closet via module 326, it is visible to them permanently by themselves and other users with access either in this users closet or other users' closets through the integrated closet system.

When the user is in the context of an item, a user via the recommend function 328 can recommend the item to other users. Via connection 330, users from database 216 can see that another user has recommended them an item.

When the user is in the context of an item, the user can use via function 332 the item with other entities in the system. Via connection 334, using an item in an outfit adds that item to an existing or new outfit to be part of that collection of items and metadata in datastore 230 as well as throughout the system. Via connection 336, using an item in a runway adds the item to the conversation to share, revise, and discuss it with the other users in the runway. Via connection 338, using an item in an event adds the item to the event so that it is tracked with the event and can be coordinated with the event and other users and analyzed by the system. Via connection 340 using an item on the user's avatar virtually “tries on” the item on the user's 3d avatar so that they may get a sense of how the item would look on them. Module 341 contains A 3d avatar of particular dimensions and image, matched to the user, so that clothes can be virtually tried on for fit and look. In preferred embodiments, the clothes are replaced from a picture with digital representations of other clothes without having a ‘naked’ body view.

System 200 maintains a virtual closet that is a seamless set of users clothes, friend's clothes (borrowed and accessible) and merchant clothes (available for purchase). Owned clothes are place in the closet by the user, borrowed cloths are placed in the closet by the user and the owner (friend), accessible clothes are placed in the closet by friends who are willing to loan the item to the user and available clothes are placed in the closet by ‘approved’ merchants for possible purchase by the user. Merchant suggestions may be made for inclusion in a users closet by analyzing existing clothes in the users closet and matching for coordination, style and taste. The matching algorithm can bias for usage frequency and particular matches of items to provide user style preferences. The user may also tag this combination for particular occasions so that the system can make suggestions for similar occasions in the future.

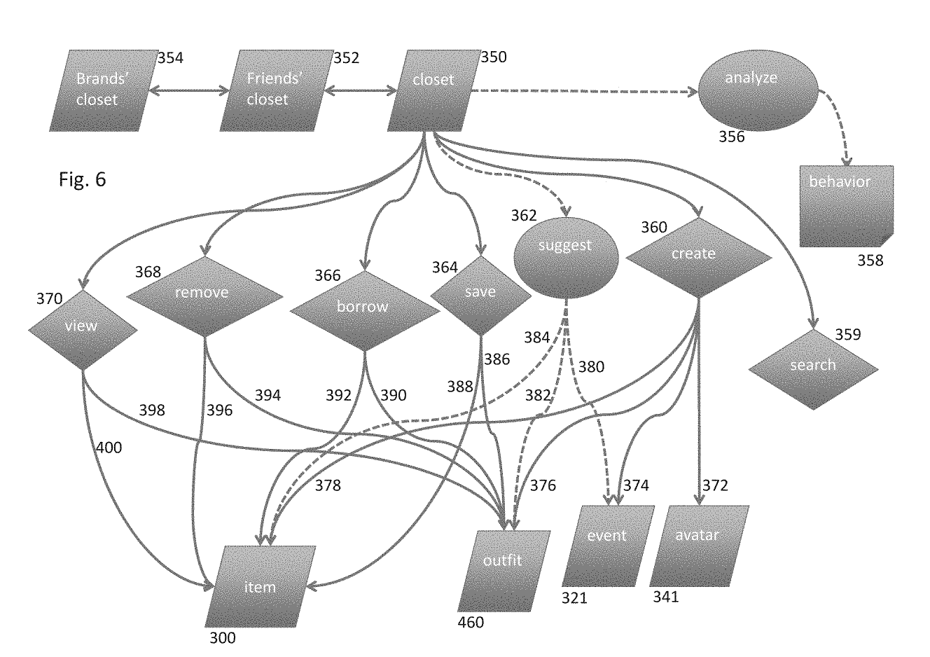

FIG. 6 shows a user and system action flowchart for interacting in the context of an integrated closet. 350. “Integrated Closets,” or “closets” for short, are a context the user can engage with that pool their items, the items of users they are associated with, 3^{rd} party items, and system generated items into an integrated display that is prioritized to user tastes by the system's analysis. When a user is interacting with a closet module 350 (where they can access their own, another user's, the system's, or 3^{rd} party's), they can interact with it by searching it, creating new content for it, saving items from it to their own closet, borrow or buy items from it, remove items from it, and viewing more detail of its entities. The system can interact with the user and the closet by suggesting a variety of actions and entities, and analyzing the behavior, context, and any other real or meta data. When a user is interacting with a closet (their own, another user's, the system's, or 3^{rd} party's), content from friends' closets may intermingle using module 352 with the content they are viewing as an “integrated closet” to better serve the user's content discovery process. When a user is interacting with a closet (their own, another user's, the system's, or 3^{rd} party's), content from brands', 3^{rd} party, or algorithmically generated closets via module 354 may intermingle with the content they are viewing as an “integrated closet” to better serve the user's content discovery process. This integrated system allows for a number of advantages including support for user clothing designed that can be ‘picked up’ by a manufacturer for production, supports for a ‘revolving closet’ where items are continuously circulated, shared, swapped or traded amongst groups of users, and supports easy packing and shipping of shared items between users.

The system via function 356 analyzes behavior, context, and any other real or meta data related to the closet and users' interaction with it in order to serve recommendations, trends, market data, and other machine intelligent derivations. Information relating to behavior, context, and any other real or meta data related to the closet and users' interaction with it is stored in behavior module 358. Via search function 359, the user may search the closet for specific or general content filtering in the process of their content discovery. When the user is in the context of a closet, the user via create function 360 can create a number of entities in the system.

When the user is in the context of a closet, the system using suggest function 362 suggests an array of entities for the user to interact with and create based on machine intelligent analysis of the item and the item's context in the other entities and learned trends in the system. When the user is in the context of a closet from anywhere in the system (other users, 3^{rd} parties, algorithms) or even their own closet through the integrated closet, the user via save function 364 can save or borrow or buy via borrow function 366 items, outfits, and other entities into their own closet permanently (until they choose otherwise). When the user is in the context of a closet from anywhere in the system (other users, 3^{rd} parties, algorithms) for which they have sufficient privileges (most likely their own closet), the user can remove via remove function 368 items, outfits, and other entities from the closet. Via details function 370 the user can view more details of entities in the closet.

The user's clothing sizes may be stored in a memory module. In preferred embodiments, the user is tied to an avatar. Users may construct and use a 3d avatar of particular dimensions, matched to the user, so that clothes can be virtually tried on for fit and looks. The avatar may be shared with friends, placed in 2 or 3 dimensional ‘settings’ for particular events and occasions for conversation and commentary. These can be uploaded to and stored in various memories to include those on mobile phones, other computers, or a central data base accessible over the Internet. Once avatars and virtual clothing have been uploaded into memory, to include that on a mobile phone, or other computer, or a central data base, these items can be stored in a virtual closet.

Via the create function 360, the user can create a 3d avatar of the user by importing photographing sufficient angles to build a 3d model of their body to test clothes on virtually or any other actions and then send via connection 372 store it in the avatar module 340. Similarly via the create function 360, the user via connection 374 can create an event with which to coordinate other users, items, outfits, and entities in the system to a real or virtual event. Connection 376 allows the user to use create function 360 to create a new outfit with the ‘outfit creator’ that has carousels of items drawn from the “integrated closet” 326 of the user, other users, and 3^{rd} parties. Items may be added via connection 378 to closet 326 by importing or photographing an apparel into the system. System 200 may suggest via connection 380 events for the user to interact with, via connection 382 outfits for the user to use or create, via suggestion 384 items for the user to consider.

When a user saves an outfit into their closet, it is visible to them permanently by themselves and other users with access either in this users closet or other users' closets through the integrated closet system via connection 386. When a user saves an item into their closet, it is visible via connection 388 to them permanently by themselves and other users with access either in this users closet or other users' closets through the integrated closet system. When a user borrows or buys an outfit, the system via 390 initiates interaction between the user and the lender/seller to transfer the outfit in the real world in a transaction. When a user borrows or buys an item, the system via connection 392 initiates interaction between the user and the lender/seller to transfer the item in the real world in a transaction. The system via connection 394 removes the outfit from the user's perspective. This may or may not delete it from other parts of the system or the system as a whole. Via connection 396, the item is also removed from the user's perspective. This may or may not delete it from other parts of the system or the system as a whole.

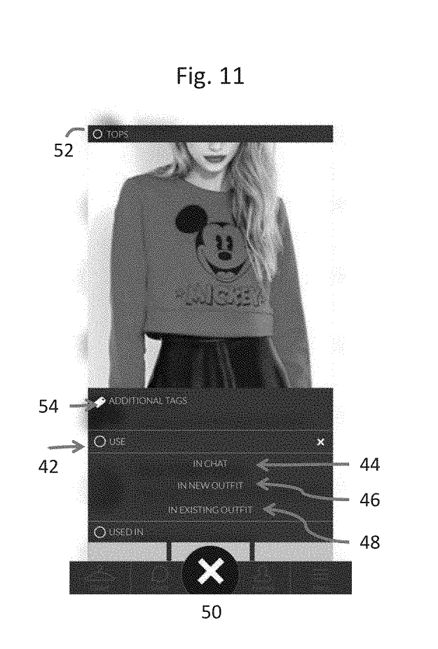

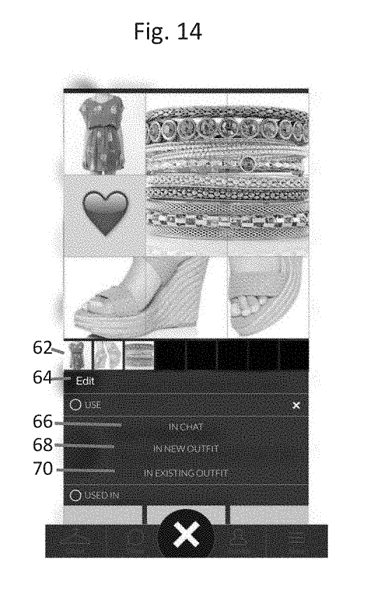

View function 370 allows the user to view more details and interactions with a particular outfit via path 398, while path 400 allows the user to view more details and interactions with a particular item (see FIGS. 11 and 14).

In keeping with the world wide interest by a billion plus individuals to communicate with each other 24/7 in real time via a user-friendly website chat mode, the system provides firstly a forum by way of a runway to discuss trends in clothing, cosmetics and the general “look” that is prevalent and changes on a minute by minute basis and secondly a means to share visual representations of particular outfits with their friends. Such visual representation to be sourced from the users closet and would include any of the users owned, borrowed, available and accessible items from their closet.

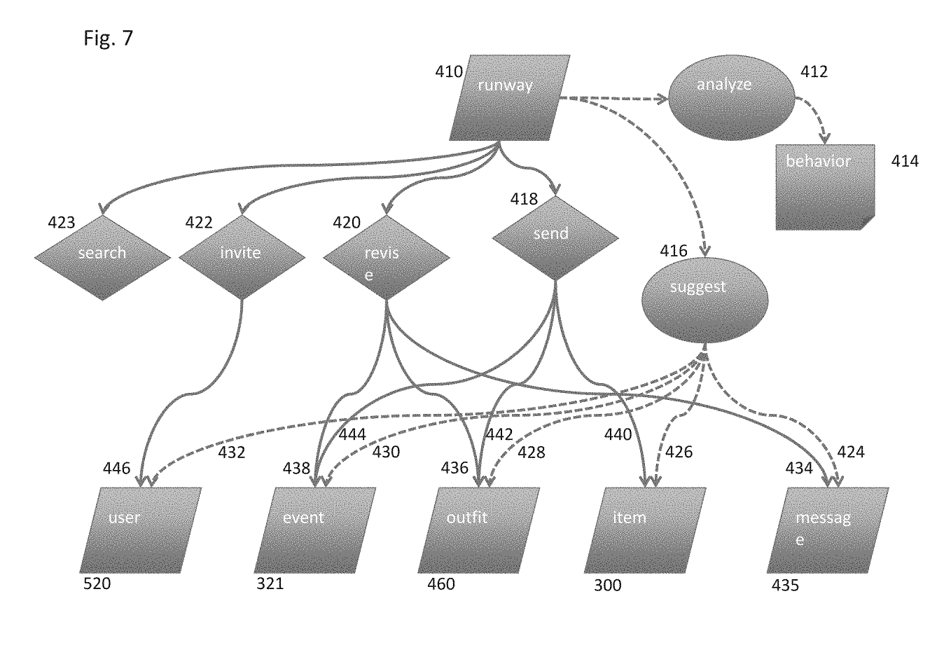

FIG. 7 shows an expanded view of runway module 222 with the user and system action flowchart for interacting in the context of a runway. When a user is interacting with a runway stored in runway data store 410, which is part of runway module 222. This may be their own runway or runways of another user's, the system's, or 3^{rd} party's. A user can interact with it by sending entities through it, revising entities in it, inviting entities to it, and searching it. The system can interact with the users and the runway by suggesting a variety of actions and entities, and analyzing the behavior, context, and any other real or meta data. System 200 via function 412 analyzes behavior, context, and any other real or meta data related to the runways and users' interaction with it in order to serve recommendations, trends, market data, and other machine intelligent derivations. Behavior module 414 includes the behavior, context, and any other real or meta data related to the runway and users' interaction with it.

When the user is in the context of a runway, the system via function 416 suggests an array of entities for the user to interact with and create based on machine intelligent analysis of the item and the item's context in the other entities and learned trends in the system. In a preferred embodiment a mixed language implementation may be used to accommodate multi-party countries and avoid censorship.

Users via send function 418 can send entities in the runway, thus adding them to the conversation to share, revise, and discuss them with the other users in the runway. Users via revised function 420 can revise entities collaboratively with other users, algorithms, systems, and 3^{rd} parties in the runway and the revisions are tracked in version history. Users via invite function 422 can invite other users or to join the runway. Users may via search function 423 search the runway for specific or general content or entities, filtering in the process of their content discovery.

System 200 via connection 424 suggests messages for the user to create, send, revise, read, focus on, share, or otherwise interact with in the runway. System 200 suggests via connection 426 to the items 226 data store for the user to send, revise, view, focus on, share, or otherwise interact with in the runway. System 200 suggests via connection 428 suggests outfits from outfits module 230 for the user to send, revise, view, focus on, share, or otherwise interact with in the runway. System 200 suggests via connection 430 suggests events from event module 242 via connection 430 for the user to send, revise, attend, read, focus on, share, or otherwise interact with in the runway. System 200 suggests via connection 432 users from module 216 for the user to invite, focus on, share, or otherwise interact with in the runway.

When the user revises a message, its version history is tracked via connection 434 when the user revises an outfit its version history is tracked via connection 436 or if an item is revised its version history is tracked via connection 438.

Sending an item via connection 440 in a runway adds the item to the conversation to share, revise, and discuss it with the other users in the runway while sending an outfit via connection 442 in a runway adds the item to the conversation to share, revise, and discuss it with the other users in the runway. Sending an outfit to a runway adds via connection 444 the item to the conversation to share, revise, and discuss it with the other users in the runway. Inviting a user via connection 446 to a runway adds the user to the conversation to share, revise, and discuss entities with the other users in the runway.

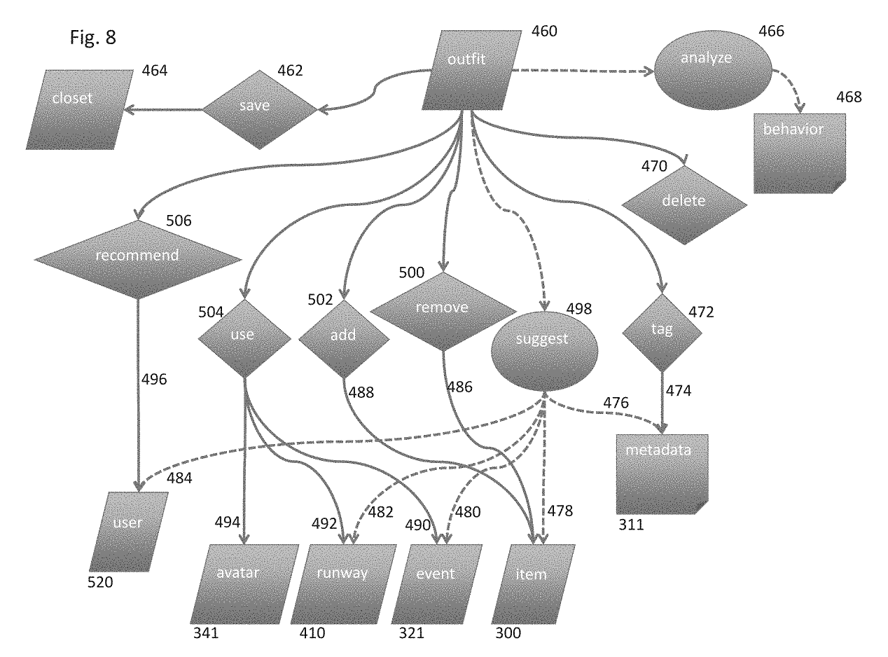

Referring to FIG. 8, which shows a more detailed view of outfits module 230. 460. Outfits are the collections apparel curated by users (individually or collaboratively), the system, or 3^{rd} parties into ‘outfits’ and stored in the system, and their associated real and meta data in the system. When a user is interacting with a particular outfit 460 (their own, another user's, the system's, or 3^{rd} party's), they can interact with it by deleting it, tagging it, removing entities from it, adding entities to it, using it in a variety of actions, recommending it to other entities, and saving it to a closet. The system can interact with the user and the outfit by suggesting a variety of actions and entities, and analyzing the behavior, context, and any other real or meta data.

When the user is in the context of an outfit from anywhere in the system (other users, 3^{rd} parties, algorithms) or even their own closet through the integrated closet, the user can save via function 462 it into their own closet 464 permanently (until they choose otherwise). When a user saves an outfit into their closet, it is visible to them permanently by themselves and other users with access either in this users closet or other users' closets through the integrated closet system.

The system via function 466 analyzes behavior, context, and any other real or meta data related to the outfit and users' interaction with it in order to serve recommendations, trends, market data, and other machine intelligent derivations. Behavior module 468 includes the behavior, context, and any other real or meta data related to the outfit and users' interaction with it.

The user may via delete function 470 delete the outfit from the user's perspective, if they have sufficient privileges. This may or may not delete it from other parts of the system or the system as a whole. The user may also via function 472 tag the outfit with metadata, which stored via connection 474 into metadata module 475 which processes data so users can search, understand, filter, and otherwise distinguish outfits while the system can run background analysis useful to vendors.

Via connection 476, the system suggests metadata to add to the outfit 460. Via connection 478, the system suggests items from module 226 for the user to add to this outfit. The system via connection 480 suggests events from module 242 for the user to use this outfit with. The system via connection 482 suggests runways from module 222 for the user to use this outfit with. The system via connection 484 suggests other users from module 216 for the user to use, recommend, revise, and otherwise interact with this outfit with. The user may via connection 486 remove an item from the outfit or via connection 488 to add an item to the outfit. When a user indicated via connection 490 that an outfit 460 has been used in an event adds the outfit to the event module 242 so that it is tracked with the event and can be coordinated with the event and other users and analyzed by the system.

Using an outfit in a runway adds the outfit via connection 492 to the conversation in runway module 222 to share, revise, and discuss it with the other users in the runway. Using an outfit on the user's avatar by connecting via connection 494 to avatar module 341 virtually “tries on” the outfit on the user's 3d avatar so that they may get a sense of how the collection of items (the outfit) would look on them. Via function 496, other users from module 210 see that the user has recommended them an item.

When the user is in the context of an outfit, the system via function 498 suggests an array of actions and entities for the user to interact with and create based on machine intelligent analysis of the outfit and the outfit's context in the other entities and learned trends in the system. When the user is in the context of an outfit, the user can remove via remove function 500 items from the collection. When the user is in the context of an outfit, the user via add function 502 can add items to the collection. When the user is in the context of an outfit, the user via use function 504 can use the item with other entities in the system. When the user is in the context of an outfit, the user via the recommend function 506 can recommend the outfit to other users.

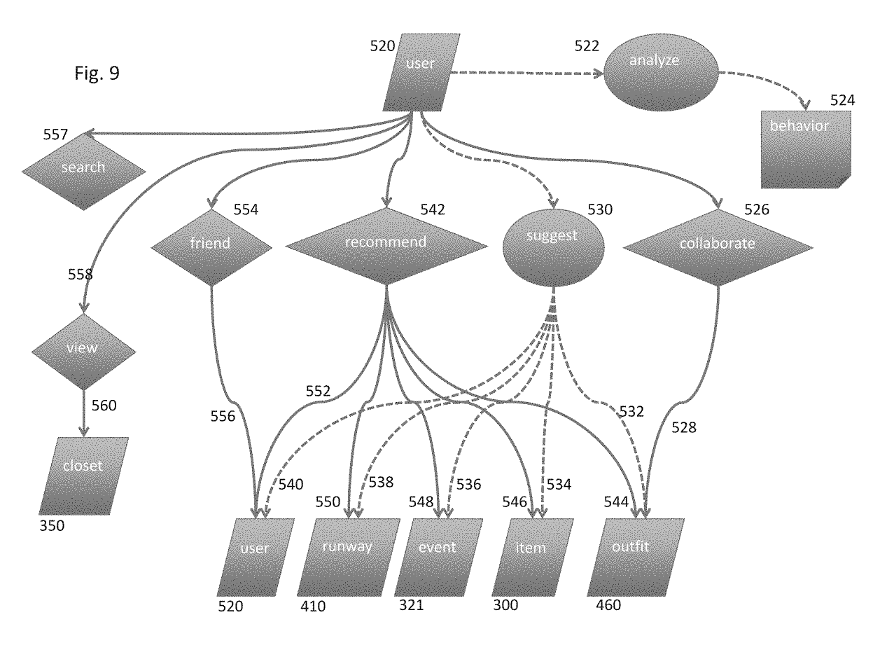

FIG. 9 shows User and system action flowchart for interacting in the context of a user. 520. Users are the entities using the system. When a user (user A) is interacting with another user (user B) via function 520 contained within user module 520 they can interact with them by collaborating on entities, recommending entities to them, ‘friending’ them, viewing entities that the user is connected to (or owns or borrows or is otherwise related), and searching the user for content or relations. The system can interact with the two users by suggesting a variety of actions and entities, and analyzing the behavior, context, and any other real or meta data. The system via analyze function 522 analyzes behavior, context, and any other real or meta data related to the users' interaction with each other in order to serve recommendations, trends, market data, and other machine intelligent derivations.

Behavior module 524 includes the behavior, context, and any other real or meta data related to the outfit and users' interaction with it. User A via collaborate function 526 invites user B to collaborate on entities in the system. Via connection 528, users A and B collaborate on creating an outfit, sharing their respective closets 464 in an “integrated closet” 350 to pool their clothes for outfit creation to be stored in outfit module 460. When the user is in the context of another user, the system via suggest function 530 suggests an array of actions and entities for the user to interact with and act on based on machine intelligent analysis of the outfit and the outfit's context in the other entities and learned trends in the system.

The system connects to outfit module 460 via connection 532 suggests an outfit for user A to create with, recommend to, collaborate on, or otherwise interact over with user B. The system connects to item module 300 via connection 534 suggests an item for user A to create with, recommend to, collaborate on, or otherwise interact over with user B.

The system may also connect to event module 321 via connection 536 to suggest an event for user A to create with, recommend to, collaborate on, or otherwise interact over with user B. The system connects to runway module 410 via connection 538 suggests a runway for user A to create with, recommend to, collaborate on, or otherwise interact over with user B. The system connects to user module 520 via connection 540 suggests another user for user A to recommend to or otherwise interact over with user B.

Using recommendation function 542, User A can recommend entities for user B to interact with (with user A or with other users or alone). Via connection 544, User A can recommend an outfit to user B. Via connection 546, User A recommends an item to user B. Via connection 548, User A recommends an event to user B. Via connection 550 User A recommends a runway to user B. Via connection 552 User A recommends another user to user B. Via function 554, User A may add user B as a friend. Via connection 560 Users A and B share additional privileges regarding each others entities and privacy and interaction in the system now that they are friends.

Using search function 557, User A searches user B's entities, content, data, meta data, and data relationships, as privileges allow. Using view function 558, User A can view entities of user B's as privileges allow. Via connection 560 to closet 350, User A can interact with user B's closet.

The integrated system with its real time communication and behavior analysis allows for users to collaborate creatively in real time. Groups of two or more users can share their wardrobes with each other, create outfits mixing all of their collections, share and track outfit iterations with each other while a user can suggest changes (edits) to another users' outfit with contributions from either closet. The system can reference wardrobes of single and multiple users for search and filtering, filter single and multiple wardrobes by brand, or other attribute, determine the level of friendship between users by the amount they talk□about clothes, predict and suggest friends based on clothes and fashion.

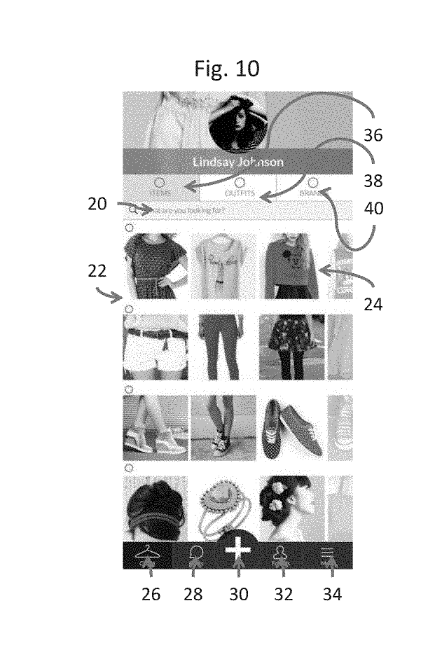

FIGS. 10-29 are screen shots of a user interface on a smartphone that can be used in connection with the inventive system.

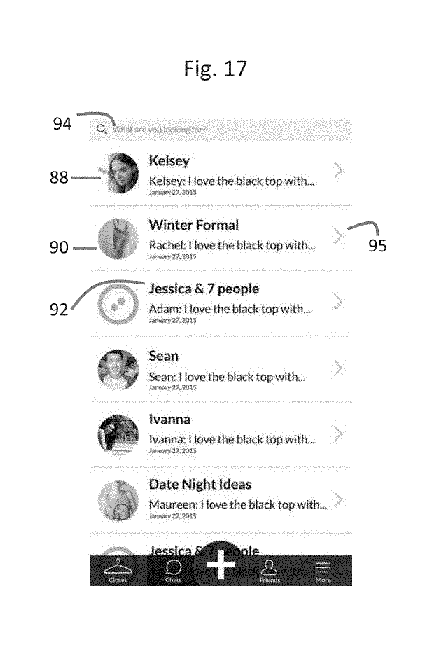

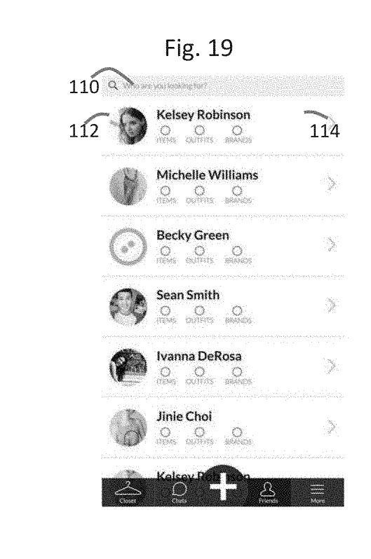

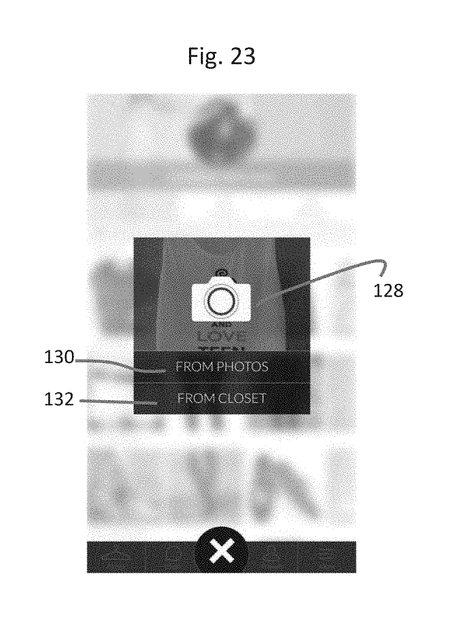

FIG. 10 is a screen view of the user's closet ‘items’ page, which shows what clothing items they own or have saved. The user may use search link 20 to type in search terms to search among those items in their virtual closet. The user via link 22 can generate ‘shelves’ to sort the items to make for more manageable viewing. Clicking on link 24 for an item initiates item-specific options (shown in more detail in ‘FIG. 11’). Hanger link 26 is used to navigate to closet (the figure we are currently on). Link 28 to access and navigate to runways (shown in more detail in FIG. 17) for further discussion. A user may click on link 30 to add content into the system (shown in more detail in FIG. 23) while link 32 is to navigate to friends (shown in more detail in FIG. 19) to then visit their closets, start runways with them, or otherwise interact. Clicking link 34 reveals further options such user account settings.

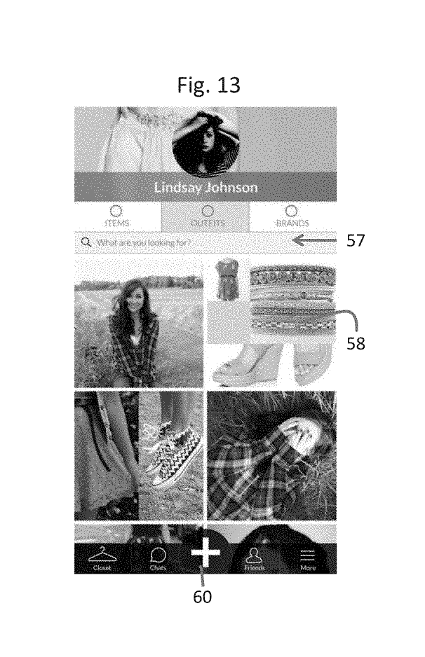

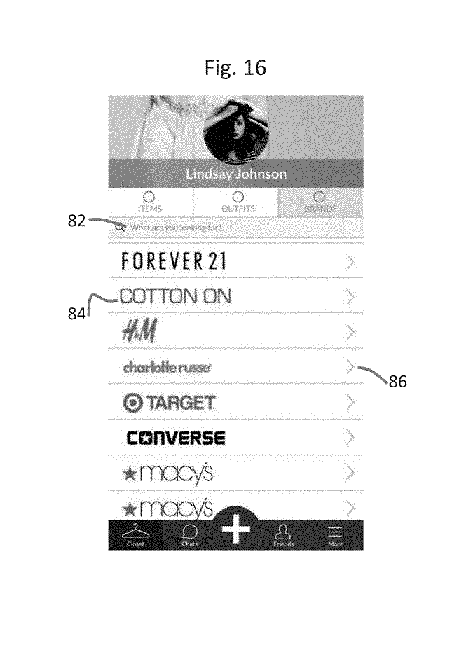

Link 36 is used view specific items while link 38 will pull up ‘outfits’ that are in the closet or allow the user to create outfits (FIG. 13). If the user wants to search for specific brands then link 40 to go to another screen limiting the view to the selected ‘brands’ (shown in more detail in FIG. 16)

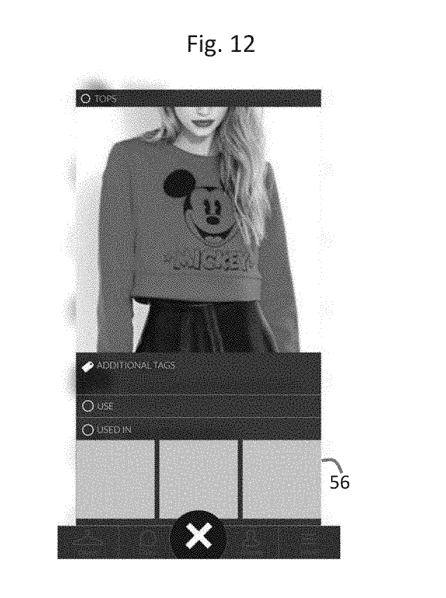

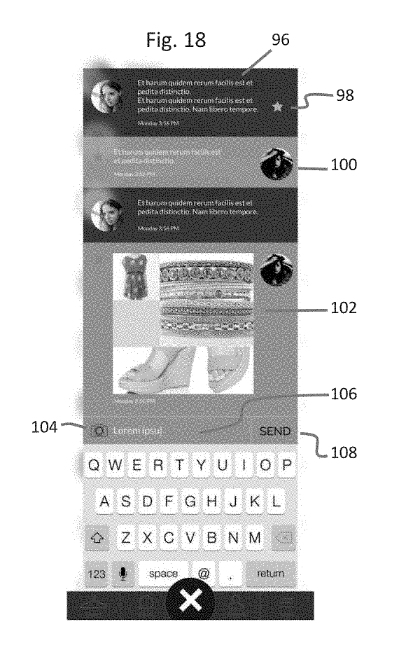

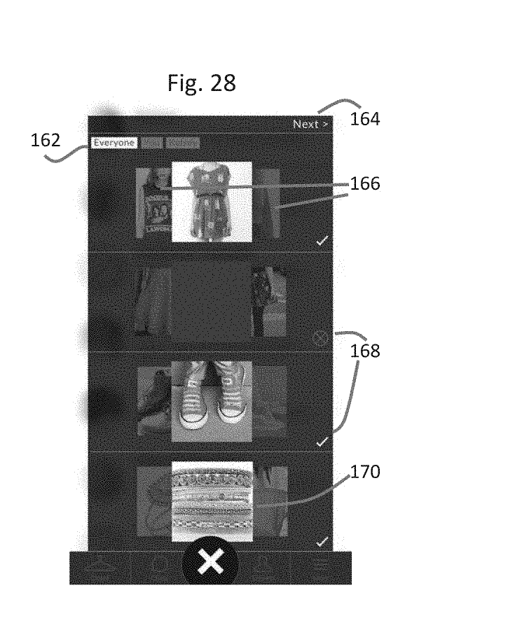

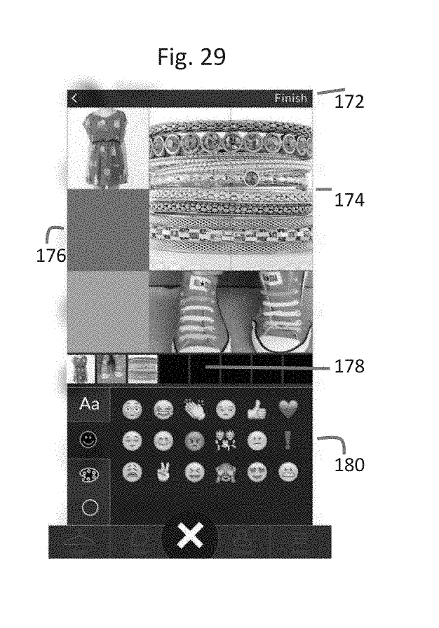

FIGS. 11 and 12 are screen views of item page where the user can review an item and its options. After the user clicks on item link 24 (screen shown in FIG. 10), link 42 may be used to access an item can be used in many contexts throughout the system. Clicking on link 44 uses the item in a runway chat (shown in more detail in FIG. 18). To use the item in a new outfit click on link 46 (FIG. 28) while clicking on link 48 allow the item to be used in an existing outfit (FIG. 29). Clicking on link 52 shows what the item's associated shelves and link 54 allow the user to review and add additional tags and metadata to the item. When the user is finished with page 41, link 50 may used to close this screen and return to screen 10. Referring to FIG. 12, link 56 is used review everywhere that the item is used in the system (runways, outfits, and other uses).

FIG. 13 is a screen view of the user's closet ‘outfits’ page 50, which shows what combinations of outfits a user owns or has saved. The user may click link 57 search outfits. Link 58 is used to select an outfit to go to its details (as shown in FIG. 14). Link 60 allows the user to add a new outfit to the system.

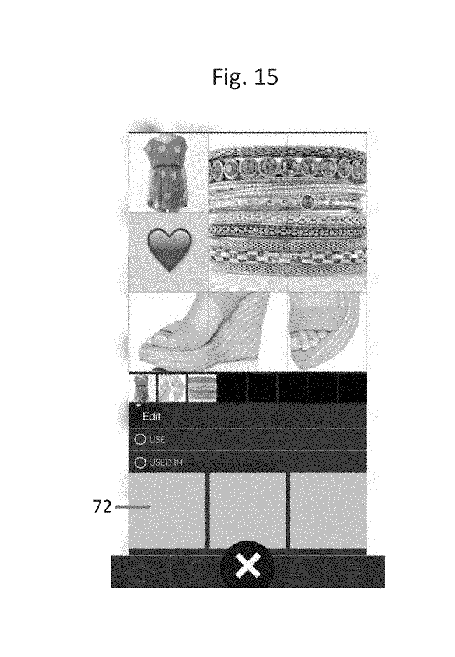

FIGS. 14 and 15 are screen views of the user reviewing an outfit and its options. A user may click on link 62 see and click for more details and options each of the items used in this outfit. A number of functions are offered on this screen including clicking on link 64 to edit the outfit (FIG. 28), clicking link 66 to use the outfit in a runway chat (FIG. 18), link 68 to use the outfit in a new outfit (FIG. 28). Link 70 allows the user to add the outfit to an existing outfit or ensemble (FIG. 29). Link 72 allows the user to review everywhere that the item is used in the system (runways, outfits, outfit revisions, and other Users can also choose which friends to include in specific groups that they can then chat to either as a group or individually. Friends may chat amongst themselves and share choices over clothes in order to help each other decide what to wear. Chat system is to select groups of friends to be chat groups—either dynamically, per chat or statically as a persistent group of friends. All chats are exclusively private to the users that are included in the chat.

FIG. 16 is a screen view of the user's closet ‘brands’ page, which shows how their behavior, choices, and other data are connected to brands. Clicking on link 82 allows the user to search brands or vendors associated with the user by the user. Link 84 on the other hand brands that the user have tagged in clothes, saved a preference for, recommended to the user by algorithms, friends, or otherwise associated with you by the system. Link 86 allows the user to click for more information on the specific brand or vendor. In a preferred embodiment, the system will prompt users when they are close to a store that sells an item on their ‘want to buy’ list.

FIG. 17 is a screen view of the user's runways or discussions. Picture 88 may show the user you are conversing with, an item that was shared in the runway, or any other media. The runway can have a name 90 of its own or display the name of chat partners. In a group runway discussion, the displayed names 92 may be shortened. Link 94 allows the user to search through the runways associated with the user. The user can select through link 95 a specific runway to view its details and options (FIG. 18).

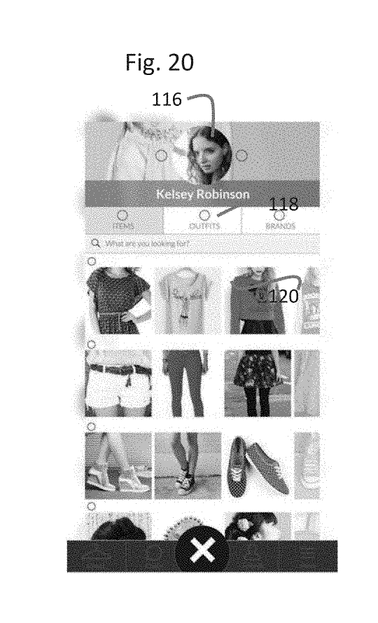

FIG. 18 is a screen view of a specific runway the user is viewing. Users via link 96 can add text into the system and send it to each other. Link 98 users can show their appreciation of messages so inform the sender while the system build up preferences metadata about the user, and save the data for future reference. Users' pictures 100 show with their messages and can be selected to show more details and options (FIGS. 20, 21, and 22). Screen portion 102 show items and outfits that are also shared in the messaging system. By clicking on link 104 the user can add new content to the system (FIG. 23) by entering text into window 106 and hitting send button 108 to send their content to others in the runway.

FIG. 19 is a screen view of the user's friends. Window 110 brings a drop down menu to search amongst the users' friends. Picture 112 and some metadata about each friend is displayed. The user may click on a friend's name 114 to select a ‘friend’ shows details and options for them (FIGS. 20, 21, and 22)

FIG. 20 is a screen view of the closet items of a fellow user where screen portion 116 includes the friends picture and metadata. Link 118 allows the user to search within the friend's items and the link 120 is used to select a friend's item for details and options (as shown earlier in FIG. 11)

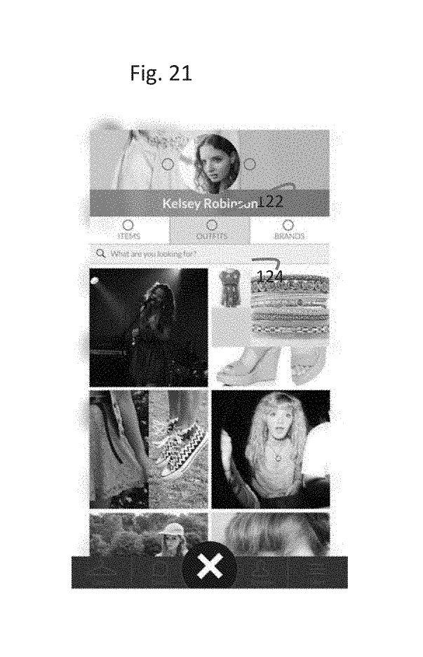

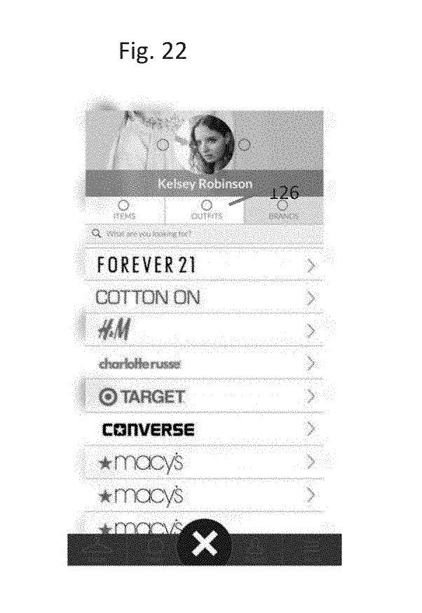

FIG. 21 is a screen view of the closet ‘outfits’ of a fellow user. Link 122 is used to search the friend's outfits while link 124 allows the user to select a friend's outfit for details and options (as shown earlier in FIG. 14). Similarly FIG. 22 is a screen view of the closet ‘brands’ of a fellow user where through link 126 a user can search the friend's brands.

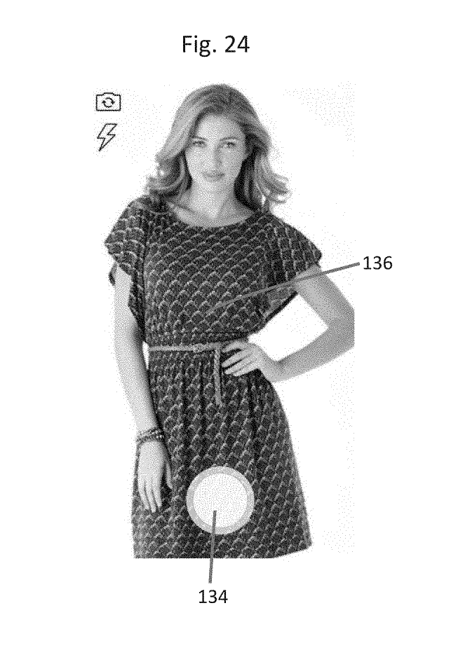

FIG. 23 is a screen view of actions with which to add new content into the system where via link 128 use, the device's camera could be used (as shown in FIG. 24), link 130 would search the device's photo library, and link 132 would use the user's closet to do some new action with existing content in the system.

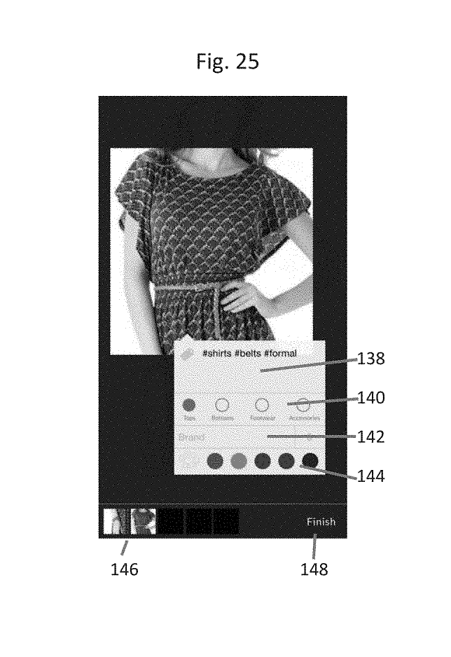

FIG. 24 is a screen view of the user taking a self-picture or item-picture to add into the system b. Link 134 is used to record the picture from the device's camera and then link 136 is used to select an area of the picture to specify the item distinct from the rest of the picture contents, to be tagged in the next step of FIG. 25.

FIG. 25 is a screen view of the user adding meta data to their item. Link 138 add meta data ‘tags’ to the item such as the type of apparel, what it means, what it's for, why they liked it, inside jokes or any other associations the user would like to make. Link 140 allows the user to choose existing, new, or algorithmically generated ‘shelves’ to categorize the item. Link 142 allows the user to add additional metadata to the item such as the manufacture brand, price, where they bought it, and other retail related information.

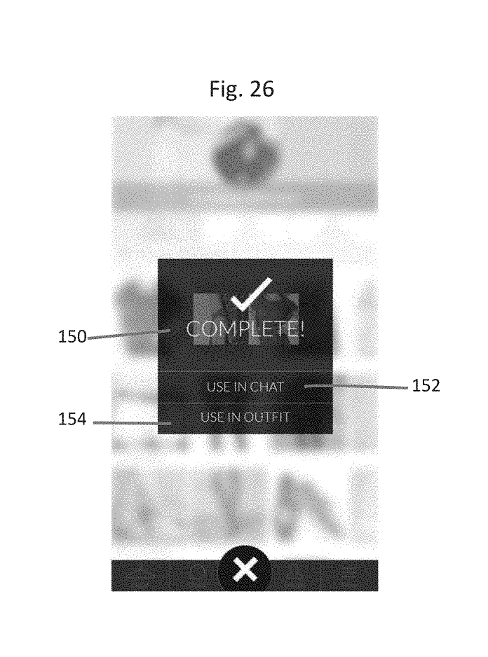

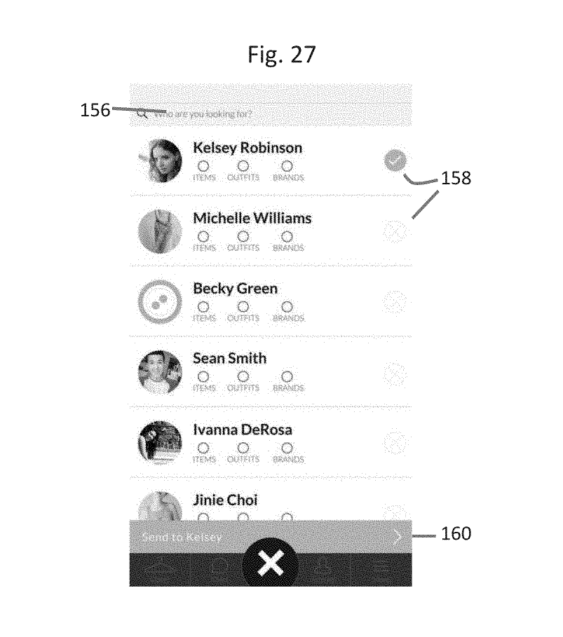

The system adjusts the algorithmically generated color tags 144 to best represent the color scheme of the item so that users can manually match close based on their color palettes, and the system can make algorithmic recommendations based on the color palettes, as well as train its learning on color fashion tagging. Link 146 allows the user to review, edit, and add more ‘items’ chosen from the same image. Link allows the user to 148 save the item(s) and image into the system and also be presented with options of adding content to the image which takes the user to the screen shown in FIG. 26. The user can click on link 150 to save the item into the user's closet without further action (FIG. 10), click on link 152 use the item in a runway discussion (FIG. 27), or click on link 154 to use the item in an outfit (FIG. 28).

FIG. 27 is a screen view of selecting friends or groups to interact with over the added content. Window 156 allows the user to search amongst friends, existing runways, and groups. Link 158 allows the user select and deselect as many friends as the user chooses. The system algorithmically recommends selections for this runway. The system maintains a history of runways, so if the user has sent something to a particular person or set of people before, this new send will bring back the context of the last runway with them in full. Then the user click on link 160 to send the content into the freshly chosen runway.

FIG. 28 is a screen view of the outfit creator-chooser. Window 162 displays any other users the user has ‘borrowed’ items from to create this outfit (e.g. by viewing a friend's closet, FIG. 20, and choosing to ‘use’ their item from FIG. 11); or that the user could ‘borrow’ from by selecting their names here to add their collections to the rotating carousel of choice. Link 164 allows the user to set the contents of the outfit and go to adding metadata. Section 166 shows for example a carousel of tops and dresses. Link 168 allows the add or remove niches (shelves, categories) for the outfit. A user may move back and forth through a manually and algorithmically curated list of items that fit a particular niche in an outfit (e.g. headgear, or torso, or scarves, or overgarment, etc.). and the another shell for skirts, pants and shorts, another for footwear, and another for accessories 170??. Items chosen here (FIG. 28) carry through as the items of the outfit (FIG. 29).

FIG. 29 is a screen view of adding more meta data to an outfit. Link 172 allows the user to finish the outfit and use it in the system (FIG. 26). A user can click on link 174 select an item to change it (FIG. 28) by choosing another item from the carousel. Area 176 displays feedback from this or other users, color palette indicators, tags, or any other auxiliary content can be part of the outfit along with the items. Link 178 allows the user to review, edit, and add to all of the items in this outfit while link 180 allows the user to add further metadata (e.g. color palettes, emojies, comments, favorites, tags, etc.) to the outfit collaboratively with friends.

The invention has been described hereinafter with reference to specific exemplary embodiments thereof. It will, however, be evident that various modifications and changes may be made thereto without departing from the broader spirit and scope of the invention. The specification and drawings are, accordingly, to be regarded in an illustrative rather than a restrictive sense. The processing functions can be realized in hardware or software. Not only are all of these processing functions realized by the hardware or software, but also part thereof may be realized by using the hardware or software. That is, the combination of the hardware and software may be adopted. Besides, various modified examples and applied examples created or combined based on the recitation of the specification are also conceivable. It should be understood by those skilled in the art that various modifications, combinations, sub-combinations and alterations may occur depending on design requirements and other factors. It should be understood that various changes and modifications to the presently preferred embodiments described herein will be apparent to those in the art. Such changes and modifications can be made without departing from the spirit and scope of the present subject matter and without diminishing its intended advantages.

What is claimed is:

1. A method for putting together outfits based on possessions, friend's possessions and purchases, giving discounts for participation and collecting revenue for providing leads.

2. Apparatus for the identification and transportation of a plurality of items, said item being selected from the group consisting of clothing, garment, jewelry, accessories and footwear, owned by a plurality of entities and located at a plurality of locations, comprising:
(a) a plurality of first and second physical storage locations;
(b) a plurality of first items available for borrowing stored in each of said first physical storage locations, and a plurality of second items available for purchase stored in each of said second physical storage locations;
(c) a plurality of images representing the visual appearance of each of said items in said plurality of items;
(d) a central server remotely located with respect to said plurality of physical storage locations;
(e) a member electronic processing device associated with each of said physical storage locations, said electronic processing device being programmed to communicate with said central server and enable the processing of information under the direction of said central server, said electronic processing device being programmed to transmit information comprising image information associated with an item to said central server and to initiate an information communication comprising a search inquiry and to collect returned search information;
(f) a vendor electronic processing device associated with a vendor entity; and
(g) an electronically accessible storage system associated with said central server, said storage system containing a program of instructions responsive to communications inputs into said central server to:
(i) store in said image storage device, in response to transmission of an image of a first item available to be lent out received from a member electronic processing device, an image of said first item, said image of said first item being associated with data relating to said first item;
(ii) store in said image storage device, in response to transmission of an image of a second item available for purchase, an image of said second item received from a vendor and available for purchase, said image of said second item being associated with data relating to said second item;
(iii) output, in response to a search inquiry a plurality of images of a plurality of responsive items responsive to said search inquiry, together with any applicable pricing information and direct transmission of the same to the member electronic processing device initiating the search inquiry;
(iv) receive from said member electronic processing device initiating said search inquiry information indicating a selection of items selected from said plurality of responsive items;
(v) generate an outfit representation using said selection of items selected from said plurality of responsive items;
(vi) cause said representation to be sent to a plurality of member electronic processing devices;
(vii) transmit information indicating the selection of said second item to a vendor associated with said second item;
(viii) maintain a database tracking the number of times items available for purchase from a vendor are selected by members;
(ix) maintain a database of member loyalty award information tracking the number of times each member has assembled an outfit and/or made an item available for borrowing to provide a basis for loyalty rewards;
(x) generate loyalty reward information and to maintain a database of loyalty reward information;
(xi) communicating loyalty reward information to said vendor to enable the execution of a purchase using said loyalty reward information; and
(xii) transmit to computing devices associated with members participating in the assembly of an outfit either as an assembler or as a contributor a message offering shipping services to enable acceptance of said offer and notification to a participating shipper of shipping information.
